(19) United States
(12) Patent Application Publication
(10) Pub. No.: US 2005/0243930 A1
(43) Pub. Date: Nov. 3, 2005

(54) Video encoding method and apparatus

(76) Inventors: Wataru Asano, Yokohama-shi (JP); Shinichiro Koto, Kokubunji-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/114,115

(22) Filed: Apr. 26, 2005

(30) Foreign Application Priority Data
Apr. 28, 2004 (JP) 2004-134252

(51) Int. Cl. H04N 7/12

(52) U.S. Cl. 375/240.16; 375/240.12; 375/240.24; 375/240.18

(57) ABSTRACT

A video encoding method includes subjecting an input video signal to prediction processing according to a plurality of encoding modes to generate an syntax element for each of the encoding modes, accumulating the number of bits of intermediate binary representation of values of the syntax element before subjecting the syntax element to arithmetic encoding for each of the encoding modes, selecting one encoding mode from the plurality of encoding modes based on the number of bits, and subjecting the syntax element corresponding to the selected encoding mode to the arithmetic encoding.

### CROSS-REFERENCE TO RELATED APPLICATIONS

This application is based upon and claims the benefit of priority from prior Japanese Patent Application No. 2004-134252, filed Apr. 28, 2004, the entire contents of which are incorporated herein by reference.

### BACKGROUND OF THE INVENTION

1. Field of the Invention

The present invention relates to a video encoding method and apparatus of performing a predictive encoding by selecting one mode from a plurality of encoding modes and subjecting the code element to arithmetic encoding.

2. Description of the Related Art

In the international standard of video encoding systems such as MPEG-2, MPEG-4 and H.264, there are a plurality of encoding modes concerning selection of a reference picture, a pixel block shape and a scheme of producing a prediction signal.

One encoding mode is selected from these encoding modes every pixel block to encode the pixel block. In these video encoding methods, it is preferable to execute an optimum encoding mode, that is, an encoding mode with the most preferable encoding efficiency. The case that the optimum encoding mode is not selected deteriorates in picture quality in performing the encoding at the same bit rate or increase in the number of encoded bits necessary for reproducing with the same picture quality in comparison with the case that the optimum encoding mode is selected. It is important to encode the picture by the optimum encoding mode every pixel block. Therefore, various techniques for selecting an encoding mode have been proposed.

For example, a patent literature 1 (Japanese Patent Laid-Open No. 10-290464) discloses a method of estimating the number of encoded bits from a prediction error signal and the like, and selecting a mode making the estimated number of encoded bits minimum.

The non-patent literature 1 (Gary J. Sullivan and Thomas Wiegand, “Rate-Distortion Optimization for Video Compression”, IEEE Signal Processing Magazine, November 1998) discloses a method of deriving the number of encoded bits by actually encoding the picture every encoding mode, computing an encoding distortion every mode, that is, an error between the decoded picture and the original picture, and selecting an encoding mode that is optimum in balance between the number of encoded bits and coding distortion.

In the method of the patent literature 1, the encoding mode is selected based on estimation of the number of encoded bits, so that the selected encoding mode may be not optimum when prediction fails. For this reason, the improvement of encoding efficiency is not always expected.

Because the method of the non-patent literature selects an encoding mode based on the result obtained by accumulating the number of encoded bits in the actual encoding, the encoding efficiency is improved. However, the technique disclosed by the non-patent literature 1 has the problem that the operations and hardwares necessary for the encoding increases in amount. As a result, the cost of an encoder increases when the number of encoding modes increases, because the number of encoded bits must be measured by performing actually encoding for a plurality of encoding modes. In particular, when an arithmetic coding is used for the entropy coding such as ITU-T Rec. H.264, this problem is remarkable.

An object of the present invention is to provide a video encoding method and apparatus capable of selecting an optimum mode with diminishing a processing load in encoding a video by selecting one mode from a plurality of encoding modes.

### BRIEF SUMMARY OF THE INVENTION

An aspect of the present invention provides a video encoding method comprising: subjecting an input video signal to prediction processing according to a plurality of encoding modes to generate an syntax element for each of the encoding modes; accumulating number of bits of intermediate binary representation of values of the syntax element before subjecting the syntax element to arithmetic encoding for each of the encoding modes; selecting one encoding mode from the plurality of encoding modes based on the number of bits; and subjecting the syntax element corresponding to the selected encoding mode to the arithmetic encoding.

Another aspect of the present invention provides a video encoding apparatus comprising: a predictor to subject an input video signal to prediction processing according to a plurality of encoding modes to generate an syntax element for each of the encoding modes; an accumulator to accumulate number of bits of intermediate binary representation of values of the syntax element before subjecting the syntax element to arithmetic encoding for each of the encoding modes; a selector to select one encoding mode from the plurality of encoding modes based on the number of bits; and an arithmetic encoder to subject the syntax element corresponding to the selected encoding mode to the arithmetic encoding.

### BRIEF DESCRIPTION OF THE SEVERAL VIEWS OF THE DRAWING

FIG. 1 is a block diagram of a video encoding apparatus according to the first embodiment of the present invention.

FIG. 2 is a diagram showing an example of a procedure to generate a bit string used in the number-of-encoded bits accumulator shown in FIG. 1.

FIG. 3 is a block diagram of an arithmetic encoder shown in FIG. 1.

FIG. 4 is a flowchart indicating a procedure of video encoding in the first embodiment.

FIG. 5 is a block diagram of a video encoding apparatus according to the second embodiment of the present invention.

FIG. 6 is a flowchart indicating a procedure of video encoding in the second embodiment.

### DETAILED DESCRIPTION OF THE INVENTION

There will now be described embodiments of the present invention referring to accompanying drawings.

(First Embodiment)

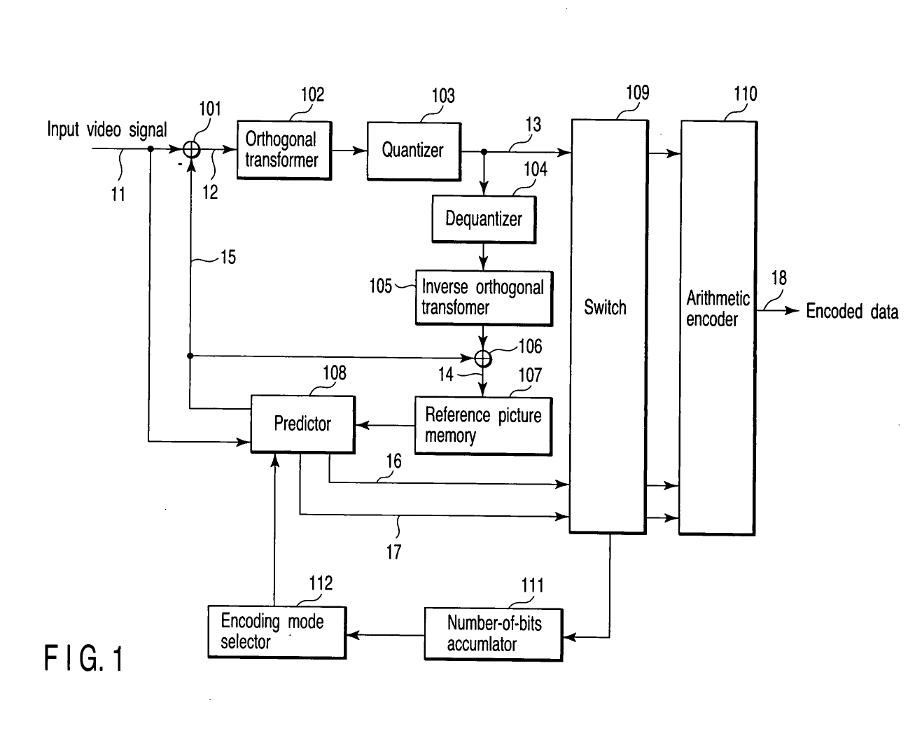

In a video encoding apparatus according to the first embodiment of the present invention, an input video signal 11 of a to-be-encoded picture is input to a subtracter 101 every pixel block as shown in FIG. 1. The subtracter 101 calculates a difference between the input video signal 11 and the prediction picture signal 15 to generate a prediction error signal 12. An orthogonal transformer 102 subjects the predictive error signal 12 to orthogonal transformation to generate an orthogonal transformation coefficient. The orthogonal transformation coefficient is quantized with a quantizer 103.

The quantized orthogonal transformation coefficient information is dequantized with a dequantizer 104, and then subjected to inverse orthogonal transformation with an inverse orthogonal transformer 105 to produce a predictive error signal.

An adder 106 adds the reproduced predictive error signal and the predictive picture signal 15 to generate a local decoded picture signal 14. The local decoded picture signal 14 is stored in a reference image memory 107 as a reference picture signal. The reference picture signal read from the reference image memory 107 is input to a predictor 108. The reference image memory 107 includes a plurality of frame memories.

The predictor 108 performs an intra-frame prediction or an inter-frame prediction to generate a predictive picture signal 15. In the inter-frame prediction, the reference picture signal from the reference image memory 107 is subjected to motion compensated prediction. The intra-frame prediction is performed according to an encoding mode based on the encoded region of the frame subjected to encoding. The predictive picture signal 15 is sent to the subtracter 101 to calculate a difference between the input video signal 11 and the predictive picture signal 15, and further send to an adder 106 to generate a local decoded picture signal 14. The predictor 108 outputs encoding mode information 16 such as a prediction mode indicating the intra-frame prediction or inter-frame prediction, a number of the reference picture selected from the reference image memory 107 and a block size at the prediction time, and motion vector information 17 used for the inter-frame prediction (motion compensated prediction).

The quantized orthogonal transformation coefficient information 13 output from the quantizer 103, the encoding mode information 16 output from the predictor 108 and the motion vector information 17 are generally referred to as code elements (syntax elements). These code elements are input to the switch 109. The switch 109 changes the code element to the arithmetic encoder 110 or the number-of-encoded bits accumulator 111.

The arithmetic encoder 110 encodes the quantized orthogonal transformation coefficient information 13, the motion vector information 16 and the encoding mode information 17, respectively, to generate codes corresponding to them, and outputs a bit stream of encoded data 18 by multiplexing these codes. The encoded data 18 is sent to a storage (not shown) or a transmission channel.

The number-of-encoded bits accumulator 111 accumulates the number of bits before subjecting the code element to arithmetic encoding from the code element input through the switch 109 using a code conversion table or computation.

| Value | bit string | the number of bits |
|---|---|---|
| 0 | 1 | 1 |
| 1 | 00 | 2 |
| 2 | 011 | 3 |
| 3 | 010 | 3 |

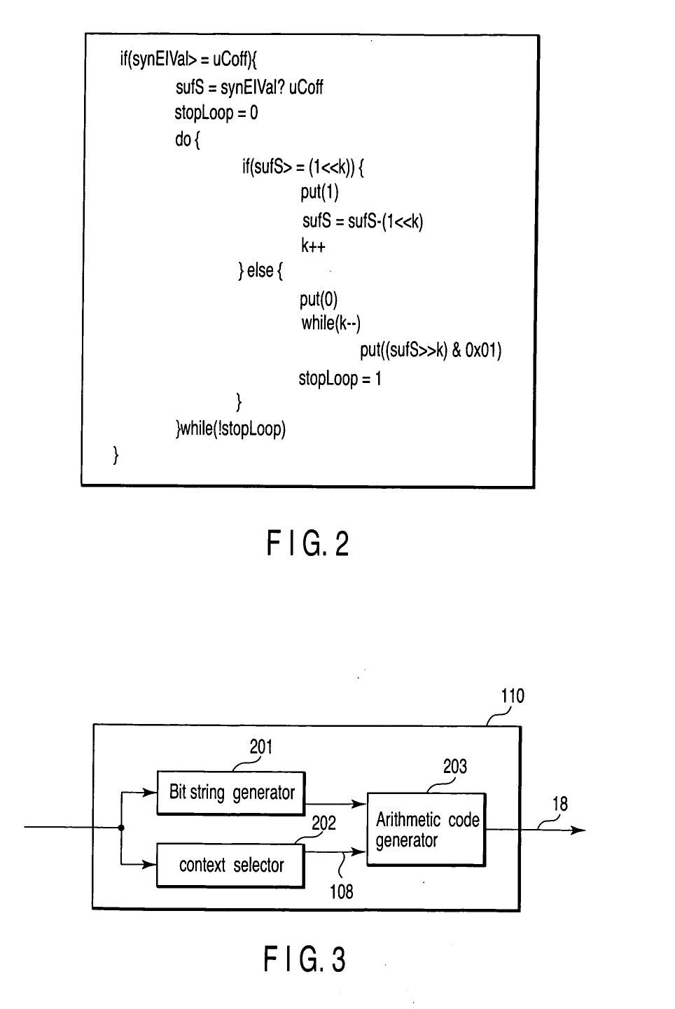

Table 1 shows an example of the code conversion table used for arithmetic encoding. Table 1 comprises Value indicating the code element such as orthogonal transformation coefficient information or encoding mode information. The bit string of variable-length code is assigned to each Value. The number-of-encoded bits accumulator 111 accumulates the number of encoded bits before arithmetic encoding with the arithmetic encoder 110 by accumulatively adding the number of bits corresponding to Values, respectively, referring to a code conversion table such as the table 1. In another example of the number-of-encoded bits accumulator 111, the number of encoded bits can be accumulated by converting Value into bit string by a process as shown in FIG. 2, for example. The number-of-encoded bits accumulator 111 does not output arithmetic encoded data but accumulates only the encoded bits.

Information of the number of encoded bits accumulated with the number-of-encoded bits accumulator 111 is input to the encoding mode selector 112. The encoding mode selector 112 determines an encoding mode based on the number-of-encoded bits information supplied from the number-of-encoded bits accumulator 111. Concretely, the encoding mode selector 112 selects one by one a plurality of encoding modes with the output of the switch 109 changed to the number-of-encoded bits accumulator 111, and sets the selected encoding mode to the predictor 108. In this time, the encoding mode selector 112 selects the encoding mode in units of pixel block.

Then, the encoding mode selector 112 selects a final encoding mode based on the number-of-encoded bits information of each encoding mode supplied from the number-of-encoded bits accumulator 111 when the picture is encoded by each encoding mode. In other words, in this time, the video encoding apparatus actually subjects the pixel block of a to-be-encoded object to predictive encoding for each of a plurality of encoding modes, and accumulates the number of encoded bits. The encoding mode selector 112 compares the number-of-encoded bits information provided for each encoding mode to select an encoding mode making the number of encoded bits minimum.

In this way, when the encoding mode selector 112 selects one encoding mode, the code elements generated by predictive encoding according to the selected encoding mode, that is, the quantized orthogonal transformation coefficient information 13, the encoding mode information 16, and the motion vector information 17 provided in the motion compensated prediction mode are input to the arithmetic encoder 110 via the switch 109. The arithmetic encoder 110 subjects to arithmetic encoding the code elements such as the quantization orthogonal transformation coefficient information 13, the encoding mode information 16 and the motion vector information 17 which are generated according to the encoding mode selected as described above to produce the encoded data 18.

The arithmetic encoder 110 comprises a bit string generator 210, a context selector 202 and an arithmetic code generator 203 as shown in FIG. 3. The bit string generator 201 converts Value indicating the code elements such as the quantized orthogonal transformation coefficient information 13, the encoding mode information 16 and the motion vector information 17 into a bit string configured by “0”, “1” by the table 1 and conversion shown in FIG. 2. On the other hand, the context selector 202 selects probability models corresponding to the input quantization orthogonal transformation coefficient information 13, the encoding mode information 16 and the motion vector information 17, respectively, and outputs the selected one. The arithmetic code generator 203 outputs the encoded data 18 according to the input bit string and probability model. The encoded data 18 output from the arithmetic encoder 110 becomes the output of the video encoding apparatus.

The more concrete procedure of the video encoding apparatus according to the first embodiment will be described. When the video signal 11 is input to the video encoding apparatus of FIG. 1 in units of one frame (step S101), encoding is started every pixel block (step S102). At first, the encoding mode selector 112 sets 0 to the index indicating an encoding mode, and initializes the variable min_cost indicating the minimum cost to the maximum (step S103).

The encoding mode selector 112 sets an encoding mode indicated by the value of index to the predictor 108 with the output of the switch 109 connected to the number-of-encoded bits accumulator 111. As a result, the provisional predictive encoding is performed by the encoding mode indicated by the value of index (step S104), and the number of encoded bits at that time is accumulated by the number-of-encoded bits accumulator 111 (step S105). The number of encoded bits accumulated here is obtained based on the number of bits before the arithmetic encoder 110 does arithmetic coding. Accordingly, because the arithmetic encoding is not actually done in accumulating the number of encoded bits, the arithmetic processing for accumulating the number of encoded bits is diminished by just that much.

The encoding mode selector 112 computes an encoding cost based on the number of encoded bits accumulated in this manner (step S106). The computed encoding cost is the number of encoded bits itself, for example. The encoding mode selector 112 determines whether the computed encoding cost is smaller than the minimum cost min_cost (step S107). When the computed encoding cost is smaller than the minimum cost, the minimum cost min_cost is updated to the computed encoding cost. The encoding mode “index” indicating the encoding mode of the provisional predictive encoding in this time is saved as a best_mode index. The provisional predictive coding result in this time, that is, information of the code element generated by the predictive encoding corresponding to the encoding mode indicated by “index” is saved (step S108).

The encoding mode selector 112 increments the encoding mode “index”, and determines whether the incremented encoding mode “index” is smaller than a predetermined value “max” (step S109). The predetermined value “max” is the number of selectable encoding modes. Accordingly, that determination consequence of step S109 is NO means that the process of steps S104 to S108 is finished about all encoding modes.

When the incremented encoding mode “index” is smaller than the value “max” (when the determination result of step S109 is YES), the steps S104 to S109 are executed by the encoding mode indicated by the incremented encoding mode “index”. Thereafter, when the encoding mode “index” becomes larger than the predetermined value “max” (when the determination result of step S109 is NO), the process of steps S104 to S108 is repeated for all of selectable encoding modes, and the encoding mode selector 112 selects the optimum encoding mode (best_mode). In other words, the encoding mode indicated by “index” and held by the best_mode index is selected as the optimum encoding mode. In this way, the encoding costs corresponding to the numbers of encoded bits for plural encoding modes are compared to one another, the encoding mode of the minimum cost can be selected as the optimum encoding mode (best_mode).

Thereafter, the predictive encoded data (a series of encoded Values) based on the selected optimum encoding mode (best_mode) is supplied to the arithmetic encoder 110 by the switch 109, so that the bit string is actually subjected to the arithmetic encoding (step S10) to produce the encoded data 18. When the process of steps S102 to S110 is done for all pixel blocks in one frame (when step S111 is YES), encoding of one pixel block of one frame is completed.

The process of generating the local decoded picture signal 14 from the quantization orthogonal transformation coefficient 13 output from the quantizer 103 via the dequantizer 104 and the inverse orthogonal transformer 105, and storing it as reference picture data in the reference picture memory 107 may be done only by the optimum encoding mode that is finally selected. Accordingly, the process for generating the local decoded picture signal 14 needs not always execute in a loop for selecting the encoding mode.

According to the first embodiment as discussed above, a nearly actual encoding process is performed for each of a plurality of selectable encoding modes. The encoding mode making the number of encoded bits of encoded data minimum is selected. The encoding is done in the selected encoding mode. Accordingly, it is possible to select an encoding mode having a high encoding efficiency, that is, an optimum encoding mode according to content of a pixel block and the like.

According to the present embodiment, the number of encoded bits accumulating is carried out with the number-of-encoded bits accumulator 111 to select an encoding mode without the arithmetic encoding with a heavy process which must be executed every one input. Hence, it is possible to carry out at high speed the number of encoded bits accumulating to be repeated every encoding mode. Further, the final entropy encoding for an code element to be provided by the selected encoding mode is done with high compressibility by means of the arithmetic encoder 110, so that the encoding efficiency of the encoded data 18 which is finally provided indicates a high value.

As described above, the present embodiment makes it possible to realize video encoding with high compression efficiency at high speed by selecting an optimum encoding mode at high speed. In particular, a video encoding system such as ITU-T Rec. H.264 adopts arithmetic encoding as entropy encoding, so that the scheme of the present embodiment is effective for the system.

(Second Embodiment)

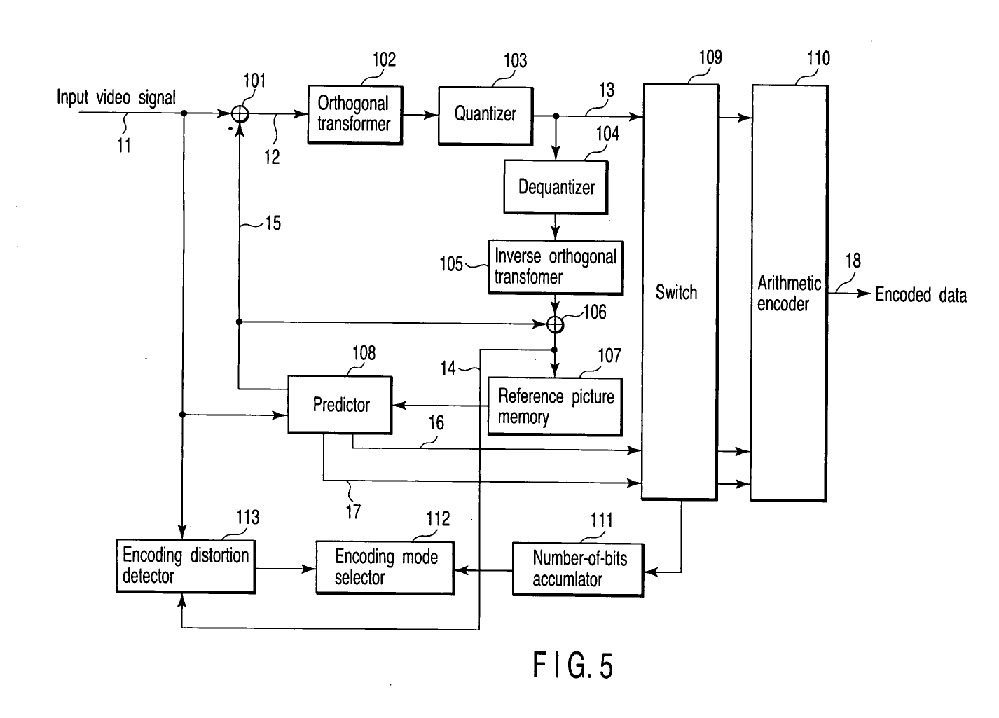

The video encoding apparatus according to the second embodiment of the present invention is described in conjunction with FIG. 5 hereinafter. The video encoding apparatus of the second embodiment includes an encoding distortion detector 113 added to the video encoding apparatus of the first embodiment as shown in FIG. 5.

In the second embodiment, like reference numerals are used to designate like structural elements corresponding to those like in the first embodiment and any further explanation is omitted for brevity's sake.

The encoding distortion detector 113 computes a coding distortion corresponding to an error (for example, square error) between an input video signal 11 of a to-be-encoded picture and a local decoded picture signal 14 produced via a dequantizer 104, an inverse orthogonal transformer 105 and an adder 106. The encoding distortion detector 113 computes encoding distortion for each encoding mode selected with an encoding mode selector 112, that is, for each of a plurality of encoding modes selectable with the video encoding apparatus. In other words, the encoding distortion representing a picture difference between an input video picture and a picture signal derived by local-decoding an code element obtained by a predictive encoding for each encoding mode is detected.

In the second embodiment, the encoding mode selector 112 selects one mode from a plurality of encoding modes based on the number of encoded bits accumulated every encoding mode by the number-of-encoded bits accumulator 111 and the coding distortion detected every encoding mode by the code distortion detector 113.

An encoding mode selection reference for the encoding mode selector 112 may be, for example, a reference that the number of encoded bits and an encoding distortion cost are digitalized every encoding mode, and an encoding mode making the weighted sum of them minimum is selected from the plurality of encoding modes. A weighing coefficient used for calculating a weighted value can be determined by Rate-Distortion Optimization disclosed in the non-patent literature 1, for example. In this way if an encoding mode is selected in consideration of the coding distortion, a preferred encoding mode can be selected with balance between the number of encoded bits and the coding distortion to make it possible to improve an encoding efficiency.

The weighting coefficient used for weighting addition is determined in consideration of a case to use the actual number of encoded bits. On the other hand, the number of encoded bits accumulated with the number-of-encoded bits accumulator 111 is the number of encoded bits of bit strings before doing arithmetic encoding. It is conceivable that the actual number of encoded bits decreases less than the number of encoded bits to be accumulated by a compression ratio due to the arithmetic encoding. The compression ratio by the arithmetic coding varies by a kind of input video, a quantization parameter (say quantization width, quantization step size) in the quantizer 103, a prediction structure of encoding (intra-frame prediction, inter-frame prediction).

Consequently, the precise optimization of encoding becomes possible by changing adaptively a weighting coefficient used for weighting addition such as (a) changing it according to a quantization parameter in predictive coding, (b) changing it in proportion to compression ratio of a frame just before, or (c) changing it in proportion to compression ratio of the encoded picture (existing encoded frame) encoded using the same prediction structure as the to-be-encoded picture (current encoded frame) of the input video signal 11. In the methods (b) and (c), the weighting coefficient varying with a compression ratio in a past certain period in the arithmetic coding is used.

In this way, when one encoding mode is selected by the encoding mode selector 112, the quantized orthogonal transformation coefficient information 13 generated by predictive encoding according to an encoding mode selected similarly to the first embodiment, the encoding mode information 16, and the motion vector information 17 provided in the motion compensated prediction mode are input to the arithmetic encoder 110 via the switch 109. The arithmetic encoder 110 subjects the quantized orthogonal transformation coefficient information 13 generated in the selected encoding mode, the encoding mode information 16 and motion vector information 17 to arithmetic encoding to output the encoded data 18.

A further concrete procedure of a video encoding apparatus is described according to the second embodiment. When the video signal 11 is input to the video encoding apparatus of FIG. 5 in units of one frame (step S201), encoding is started every pixel block (step S202). In this case, at first the encoding mode selector 112 sets the index indicating an encoding mode at 0, and further initializes a variable min_cost indicating a minimum cost in a maximum (step S203).

The encoding mode selector 112 sets an encoding mode shown by the value of index to the predictor 208 with the output of the switch 109 connected to the number-of-encoded bits accumulator 111. The provisional predictive coding is performed in the encoding mode shown by the value of index (step S204). The number of encoded bits at that time is accumulated with the number-of-encoded bits accumulator 111 (step S205). The number of encoded bits accumulated here is pursued based on the number of bit before the arithmetic encoder 110 does arithmetic coding. Accordingly, because the arithmetic coding is not actually done in accumulating the number of encoded bits, the arithmetic processing for accumulating the number of encoded bits is decreased by just that much.

On the other hand, the local decoded picture signal 14 (provisional decode picture) is generated from the quantized orthogonal transformation coefficient 13 output from the quantizer 103 with the dequantizer 104 and the inverse orthogonal transformer 105 (step S206).

The coding distortion (for example, square error) that is an error between the input video signal 11 corresponding to the to-be-encoded picture and the local decoded picture signal 14 generated in step S206 is computed with the encoding distortion detector 113 (step S207).

The encoding mode selector 112 computes an encoding cost based on the number of encoded bits accumulated in step S205 (step S208). The calculated encoding cost is the number of encoded bits itself, for example.

The encoding mode selector 112 determines whether the sum of values obtained by digitalizing the computed encoding cost and the coding distortion is smaller than the minimum cost min_cost (step S209), when the sum is smaller than the minimum cost, the minimum cost min_cost is updated to the computed encoding cost. The encoding mode “index” indicating the encoding mode of the provisional predictive encoding of the case is saved as a best_mode index. The provisional predictive encoded result of this time, that is, information of code element generated by the predictive encoding corresponding to an encoding mode indicated by “index” is saved (step S210). The encoding mode selector 112 increments the encoding mode “index” and determines whether the incremented encoding mode “index” is smaller than a predetermined value “max” (step S211). The predetermined value “max” is the number of selectable encoding modes. Accordingly, that determination of step S211 is “NO” means that the process of steps S204 to S210 is completed for all encoding modes. When the incremented encoding mode “index” is smaller than the value “max” (when the determination result of step S211 is YES), the process of steps S204 to S210 is performed in the encoding mode indicated by the incremented encoding mode “index”.

Thereafter, when the encoding mode “index” became larger than a predetermined value “max” (when a determination result of step S211 is NO), the process of steps S204 to S210 is repeated for all of selectable encoding modes, and the encoding mode selector 112 selects the optimum encoding mode (best_mode) from among the selectable encoding modes. In other words, an encoding mode indicated by “index” held by a best_mode index is selected as the optimum encoding mode. In this way encoding costs corresponding to the numbers of encoded bits in the encoding modes are compared to one another, and the mode making the encoding cost minimum can be selected as the optimum encoding mode (best_mode).

Thereafter, the predictive encoded data (a series of encoding Value) in the selected optimum encoding mode (best_mode) is supplied to the arithmetic encoder 120 with the switch 209. The arithmetic encoder subjects a bit string to arithmetic coding (step S212) to output the encoded data 18.

When the process of steps S202 to S212 is done for all pixel blocks of one frame (step S213 is YES), the encoding of the pixel blocks of one frame is completed.

The process of generating the local decoded picture signal 14 from the quantization orthogonal transformation coefficient 13 output from the quantizer 203 via the dequantizer 204 and the inverse orthogonal transformer 205, and storing it as reference picture data in the reference picture memory 207 may be done only by the optimum encoding mode that is finally selected. Accordingly, the process for generating the local decoded picture signal 14 does not have to be always executed in a loop for selecting an encoding mode.

In the second embodiments as discussed above, a nearly actual encoding process is performed for each of a plurality of selectable encoding modes, the number of encoded bits of encoded data in each encoding mode are accumulated, and encoding distortion is computed every encoding mode. An encoding mode decreasing picture degradation and making the number of encoded bits decrease is selected based on the number of encoded bits of each encoding mode and the encoding distortion.

Similarly to the first embodiment, the number-of-encoded bits accumulating is carried out with the number-of-encoded bits accumulator 111 to select an encoding mode without the arithmetic encoding with a heavy process which must be executed every one input. Hence, it is possible to carry out at high speed the number of encoded bits accumulating to be repeated every encoding mode.

Further, the final entropy encoding for an code element to be provided by the selected encoding mode is done with high compressibility with the arithmetic encoder 110, so that the encoding efficiency of the encoded data 18 which is finally provided indicates a high value. As described above, the present embodiment makes it possible to realize video encoding with high compression efficiency at high speed by selecting an optimum encoding mode at high speed.

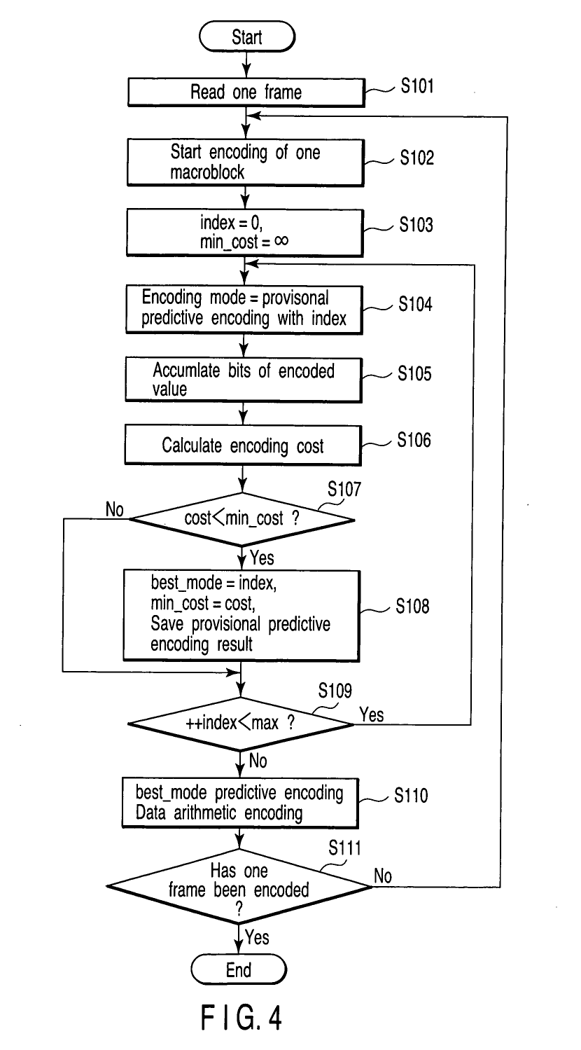

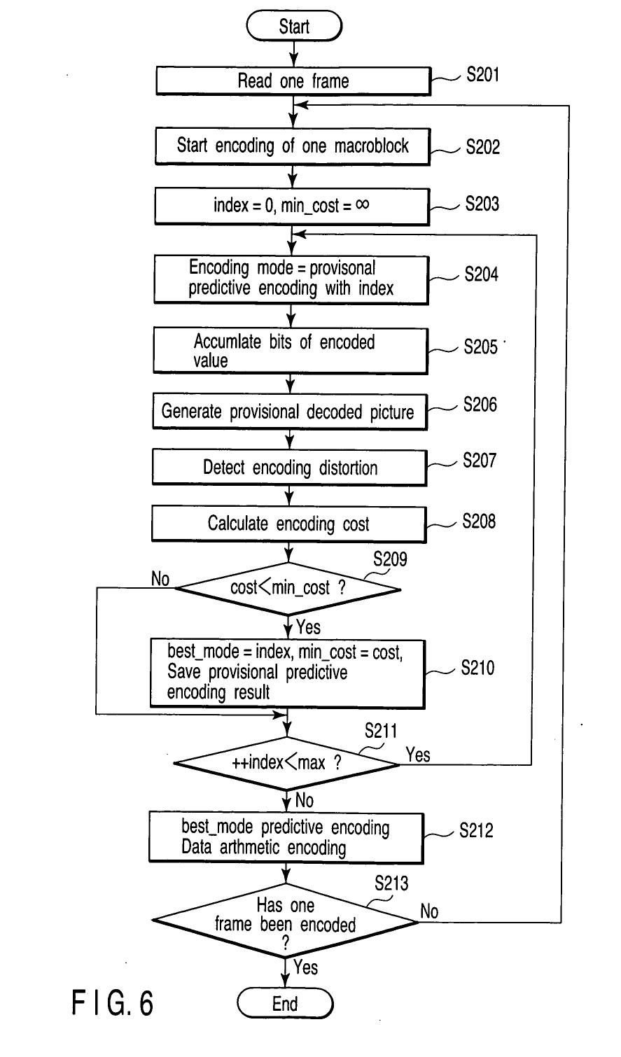

The video encoding process done in each embodiment described above may be realized by means of dedicated hardware. Alternatively, the video encoding process that <S> seems to have shown in FIG. 4 including encoding mode selection and FIG. 6 may be carried out by CPU working according to a program. The video encoding process including encoding mode selection as shown in FIGS. 4 and 6 may be carried out by a CPU operating according to a program. A program to make a computer execute such a video encoding process may be provided to a user via a communication line such as Internet. The program may be provided to a user with being recorded in a computer readable medium such as CD-ROM (Compact Disc-Read Only Memory).

According to the present invention, when the video encoding is performed selecting one mode from a plurality of modes, an optimum mode can be selected while the burden of processing for the video encoding is suppressed.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A video encoding method comprising:
subjecting an input video signal to prediction processing according to a plurality of encoding modes to generate an syntax element for each of the encoding modes;
accumulating number of bits of intermediate binary representation of values of the syntax element before subjecting the syntax element to arithmetic encoding for each of the encoding modes;
selecting one encoding mode from the plurality of encoding modes based on the number of bits; and
subjecting the syntax element corresponding to the selected encoding mode to the arithmetic encoding.

2. The encoding method according to claim 1, wherein subjecting the input video signal to the prediction processing includes selecting one by one the encoding modes, and subjecting the input video signal to the prediction in units of pixel block according to each of the plurality of encoding modes, and the selecting includes selecting one encoding mode making the number of bits of intermediate binary representation of values of syntax element minimum.

3. The encoding method according to claim 1, wherein subjecting the input video signal to the prediction processing includes subjecting the input video to prediction processing to generate orthogonal transformation coefficient information, encoding mode information and motion vector information as syntax elements, and subjecting the syntax element to the arithmetic encoding includes subjecting to the arithmetic encoding the orthogonal transformation coefficient information, the encoding mode information and the motion vector information as syntax elements which are generated according to the selected encoding mode.

4. The encoding method according to claim 1, wherein encoding the syntax element to the arithmetic encoding includes converting the syntax element to a bit string, selecting a provability mode corresponding to the syntax element, and outputting encoded data according to the bit string and the probability model.

5. A video encoding method comprising:
subjecting an input video signal to prediction processing according to a plurality of encoding modes to generate an syntax element for each of the encoding modes;
accumulating number of bits of intermediate binary representation of values of the syntax element before subjecting the syntax element to arithmetic encoding for each of the encoding modes;
detecting an error between the input video signal and a local decoded picture signal generated based on the syntax element,
selecting one encoding mode from the plurality of encoding modes based on the number of bits and the error; and
subjecting the syntax element corresponding to the selected encoding mode to the arithmetic encoding.

6. The encoding method according to claim 5, wherein subjecting the input video signal to the prediction processing includes subjecting the input video to prediction processing to generate orthogonal transformation coefficient information, encoding mode information and motion vector information as syntax elements, and subjecting the syntax element to the arithmetic encoding includes subjecting to the arithmetic encoding the orthogonal transformation coefficient information, the encoding mode information and the motion vector information as syntax elements which are generated according to the selected encoding mode.

7. The method according to claim 5, wherein the selecting includes calculating weighted sum of the number of bits and the error obtained for each of the encoding modes, and selecting the encoding mode making the weighted sum minimum.

8. The method according to claim 7, wherein the calculating includes calculating the weighted sum using weighing coefficient varying according to a quantization parameter in the predictive encoding.

9. The method according to claim 7, wherein the calculating includes calculating the weighted sum using a weighting efficient varying a compression ratio in a past given period in the arithmetic encoding.

10. A video encoding apparatus comprising:
a predictor to subject an input video signal to prediction processing according to a plurality of encoding modes to generate an syntax element for each of the encoding modes;
an accumulator to accumulate number of bits of intermediate binary representation of values of the syntax element before subjecting the syntax element to arithmetic encoding for each of the encoding modes;
a selector to select one encoding mode from the plurality of encoding modes based on the number of bits; and
an arithmetic encoder to subject the syntax element corresponding to the selected encoding mode to the arithmetic encoding.

11. The apparatus according to claim 10, which further includes
an error calculator to calculator an error between the video signal and a local decoded picture signal generated based on the syntax element, and wherein the selector is configured to select one encoding mode from the plurality of encoding modes based on the number of bits of intermediate binary representation of values of the syntax element and the error.

12. The apparatus according to claim 10, wherein the predictor includes a sequential selector to select one by one the encoding modes, and a predictor to subject the input video signal to prediction processing in units of pixel block according to each of the plurality of encoding modes, and the selector includes a selector to select one encoding mode making the number of bits minimum.

13. The apparatus according to claim 10, wherein the predictor includes a predictor to subject the input video to the prediction processing to generate orthogonal transformation coefficient information, encoding mode information and motion vector information as syntax elements, and the arithmetic encoder includes an encoder to arithmetic-encode the orthogonal transformation coefficient information, the encoding mode information and the motion vector information as syntax elements which are generated according to the selected encoding mode.

14. The apparatus according to claim 10, wherein the arithmetic encoder includes a converter to convert the syntax element to a bit string, a provability mode selector to select a provability mode corresponding to the syntax element, and an arithmetic code generator to output encoded data according to the bit string and the probability model.

15. A video encoding apparatus comprising:
a predictor to subject an input video signal to prediction processing according to a plurality of encoding modes to generate an syntax element for each of the encoding modes;
a accumulator to accumulate number of bits of intermediate binary representation of values of the syntax element before arithmetic-encoding the syntax element for each of the encoding modes;
an error detector to detect an error between the input video signal and a local decoded picture signal generated based on the syntax element;
an encoding mode selector to select one encoding mode from the plurality of encoding modes based on the number of bits and the error; and
an arithmetic encoder to arithmetic-encode the syntax element corresponding to the selected encoding mode.

16. The apparatus according to claim 15, wherein the encoding mode selector includes a calculator to calculate a weighted sum of the number of bits and the error obtained for each of the encoding modes, and a final encoding mode selector to select the encoding mode making the weighted sum minimum.

17. A video encoding program stored in a computer readable medium, the program comprising:
means for instructing a computer to generate an syntax element by subjecting an input video signal to prediction processing according to a plurality of encoding modes;
means for instructing the computer to accumulate number of bits of intermediate binary representation of values of syntax element before subjecting the syntax element to arithmetic encoding for each of the encoding modes;
means for instructing the computer to select one encoding mode from the plurality of encoding modes based on the number of bits; and
means for instructing the computer to subject the syntax element corresponding to the selected encoding mode to the arithmetic encoding.

18. A video encoding program stored in a computer readable medium, the program comprising:
means for instructing a computer to generate an syntax element by subjecting an input video signal to prediction processing according to a plurality of encoding modes;
means for instructing the computer to accumulate number of bits of intermediate binary representation of values of syntax element before subjecting the syntax element to arithmetic encoding for each of the encoding modes;
means for instructing the computer to detect an error between local decoded picture signals generated based on the video signal and the syntax element;
means for instructing the computer to select one encoding mode from the plurality of encoding modes based on the number of bits and the error; and
means for instructing the computer to subject the syntax element corresponding to the selected encoding mode to the arithmetic encoding.
